(19) United States
(12) Patent Application Publication
(10) Pub. No.: US 2001/0053747 A1
(43) Pub. Date: Dec. 20, 2001

(54) THERMAL TRANSFER IMAGE-RECEIVING SHEET

(76) Inventor: YOSHIHIKO TAMURA, TOKYO-TO (JP)

Correspondence Address: THOMAS F PETERSON, LADAS & PARRY, 224 SOUTH MICHIGAN AVENUE, CHICAGO, IL, 60604

(21) Appl. No.: 09/185,783

(22) Filed: Nov. 4, 1998

(30) Foreign Application Priority Data
Nov. 6, 1997 (JP) P09-304143

(51) Int. Cl. B41M 5/28

(52) U.S. Cl. 503/227

(57) ABSTRACT

A thermal transfer image-receiving sheet comprises a substrate sheet and a dye receptor layer disposed on at least one surface side of the substrate sheet, the dye receptor layer comprising a copolymer comprising styrene compound monomer and acrylic compound monomer and a plasticizer selected from the group consisting of phosphoric ester compounds, phthalic acid ester compounds, trimellitic acid ester compounds and dibasic aliphatic acid ester compounds. The thermal transfer image-receiving sheet is capable of forming an image excellent in density of coloring, sharpness/clearness and durability in various aspects, in particular light resistance.

### BACKGROUND OF THE INVENTION

1. Field of the Invention

The present invention relates to a thermal transfer image-receiving sheet adapted for thermal transfer recording using a sublimation dye.

2. Description of the Related Art

Many attempts has been made for a thermal transfer image-receiving sheet in which a dye receptor layer is provided on at least one surface of a substrate sheet in order to improve sensitivity in dye-transfer of the dye receptor layer, durability in various aspect and stability in preservation of a formed image.

Japanese Patent Application Laid-Open (Kokai) Nos. 57(1982)-1639370 and Nos. 60(1985)-25793 disclose an attempt to form the dye receptor layer out of polycarbonate resins, polyvinyl butyral resins, polyester resins, vinyl resins such as polyvinyl chloride, cellulose resins, acrylic resins, polyolefine resins, polystyrene resins or the like. In such an thermal transfer image-receiving sheet, the sensitivity in dye-transfer of the dye receptor layer, the durability in various aspect and the stability in preservation of the formed image depend on a resin forming the dye receptor layer. In particular, light resistance of the formed image depends largely on constitution of the resin forming the dye receptor layer. Choice of the resin having an optimum constitution is therefore required for formation of the dye receptor layer.

Styrene resins are ones excellent in light resistance, and Japanese Patent Application Laid-Open (Kokai) Nos. 62(1987)-189195 discloses various styrene resins optimized for formation of the dye receptor layer of the thermal transfer image-receiving sheet.

On the other hand, since dyeing sensitivity of the dye receptor layer can be improved by increasing diffusion of the dye at the time of thermal transfer, there are known, as a technique for improvement of the dyeing sensitivity, a technique in which a resin having a low grass transition temperature (Tg) is used to form the dye receptor layer and the other technique in which a plasticizer is added into the dye receptor layer. Japanese Patent Application Laid-Open (Kokai) Nos. 5(1993)-193256 discloses a coloring matter-receptive element, a support member of which is provided with a coloring matter receptor layer comprising a vinyl copolymer having a grass transition temperature in a range of 50 to 100° C. and a plasticizer having a molecular weight in a range of 150 to 1000.

However, since almost all resins having an excellent light resistance such as polycarbonate resins, polyvinyl acetal resins or the like have a high grass transition temperature (Tg) except the polystyrene resins, there has been a problem that the dye receptor layer formed of such an resin does not have an sufficient dyeability.

In addition, when the above described plasticizer is added into the dye receptor layer for the purpose of imparting an sufficient dye-transfer property to the extent of an improved sensitivity, a mutual compatibility of the resin forming the dye receptor layer and the plasticizer goes small unless a chemical construction or physical properties of the plasticizer are optimized for the resin forming the dye receptor layer, thus causing various problems. More specifically, if the compatibility is small, the plasticizer or the resin having a low Tg is successively bled out of the formed receptor layer to change transferability and diffusivity of the dye, thereby causing a successive change of a recording sensitivity. If the compatibility is further small, fixation of the dye goes insufficient to cause blur at recording of an image, and tacking or blocking of the receptor layer may also appear to make even printing impossible. In addition, though any trouble does not appear at recording of the image, there may be caused, at a high temperature preservation in particular, blur of the recorded image and deterioration in light resistance of the image due to the breeding out occurring after recording.

### SUMMARY OF THE INVENTION

The object of the present invention is to eliminate the above described drawbacks, and more specifically, to provide a thermal transfer image-receiving sheet capable of forming an image excellent in density of coloring, sharpness or clearness and durability of various aspects.

The thermal transfer image-receiving sheet according to the present invention comprises a substrate sheet and a dye receptor layer disposed on at least one surface side of the substrate sheet, the dye receptor layer comprising a copolymer and a plasticizer, the copolymer comprising styrene compound monomer and acrylic compound monomer, and the plasticizer being selected from the group consisting of phosphoric ester compounds, phthalic acid ester compounds, trimellitic acid ester compounds and dibasic aliphatic acid ester compounds.

It is preferable to use, as the acrylic compound monomer, at least one selected from the group consisting of acrylonitrile, acrylic acid ester, acrylamide and methyl methacrylate. The use of the acrylonitrile is particularly preferable.

An amount ratio of the above described copolymer and the plasticizer (copolymer:plasticizer) is preferably set within a range of 5:5 to 9:1 in weight.

The dye receptor layer may further comprises a release agent selected from the group consisting of silicone resins and cross-linked products thereof. Of these silicone resins and cross-linked products thereof, it is preferable to use at least one selected from the group consisting of epoxy-modified silicones and non-modified silicones.

The above described copolymer may have a grass transition temperature of 100 C. or more. The use of the copolymer having a high grass transition temperature enables to secure a particularly excellent light resistance. In addition, even if the copolymer having a grass transition temperature of 100 ° C. or more is used as a binder resin of the dye receptor layer, a function of the plasticizer to improve the density in coloring is not obstructed insofar as the copolymer comprises styrene compound monomer and acrylic compound monomer.

### BRIEF DESCRIPTION OF THE DRAWINGS

FIG. 1 is a schematically sectional view of one thermal transfer image-receiving sheet according to the present invention.

### DETAILED DESCRIPTION OF THE PREFERRED EMBODIMENTS

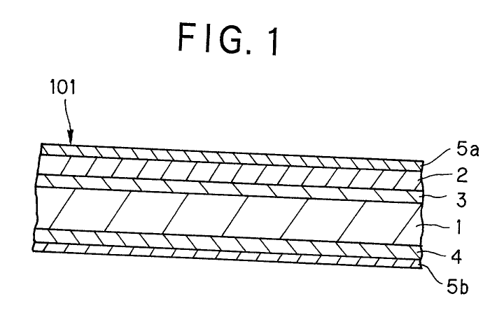

FIG. 1 is a sectional view showing one example of the thermal transfer image-receiving sheet. The thermal transfer image-receiving sheet 101 of FIG. 1 comprises a substrate sheet 1 and a dye receptor layer 2 disposed on at least one surface side of the substrate sheet 1. The thermal transfer image-receiving sheet 1 may be provided with any additional layer as required. For example, there may be disposed: an intermediate layer 3 between the substrate sheet 1 and the dye receptor layer 2; a back surface layer 4 on a surface of the substrate sheet 1 opposite to the surface having the dye receptor layer 2; and an antistatic layer (5a, 5b) on the dye receptor layer 2 and/or the back surface layer 4.

The respective portions constituting the thermal transfer image-receiving sheet of the present invention will be described in detail hereinafter.

(Substrate Sheet)

As materials for the substrate sheet of the thermal transfer image-receiving sheet, there are exemplified synthetic papers such as a polyolefine synthetic paper, a polystyrene synthetic paper or the like; cellulose-fiber papers such as a fine paper, an art paper, a coat paper, a cast coat paper, a wall paper, a back lining paper, a synthetic resin impregnated paper, an emulsion impregnated paper, synthetic rubber-latex impregnated paper, a synthetic resin containing paper, a paperboard or the like; plastic films or plastic sheets made of synthetic resins such as polyolefine, polystyrene, polycarbonate, polyethylene terephthalate, polyvinyl chloride, polymethacrylate or the like; white opaque films made by incorporating a white pigment or a filler into the above synthetic resin and then converting the resins into a film; foamed films made by foaming the above synthetic resin. Layered products made by laminating the above described materials in optional combination are also usable, and there may be representatively exemplified a layered product made by combining the cellulose-fiber paper with the synthetic paper or the plastic film or sheet.

Thickness of the substrate sheet is optional, and usually in a range of about 10 to 300 μm.

When the substrate sheet is lacking in adhesion to the dye receptor layer to be formed thereon, it is preferable to subject a surface of the substrate sheet to a treatment for improving adhesion such as primer treatment, corona discharge treatment, plasma treatment or the like.

(Dye Receptor Layer)

The dye receptor layer is disposed on at least one surface of the substrate sheet via one or more proper intermediate layers or no intermediate layer, and it has functions to receive a dye migrating from a thermal transfer sheet and retain a formed image. The dye receptor layer comprises a copolymer composed of at least styrene compound monomer and acrylic compound monomer and a plasticizer selected from the group consisting of phosphoric ester compounds, phthalic acid ester compounds, trimellitic acid ester compounds and dibasic aliphatic acid ester compounds.

When there is intention to make the thermal transfer image-receiving sheet capable of forming an image excellent in light resistance, it is required in general to form the dye receptor layer with the use of a resin having a relatively high grass transition temperature (Tg) such as styrene resins, polycarbonate resins, polyvinyl acetal resins or the like. These resins however can not secure a high density in coloring.

Accordingly, addition of the plasticizer is necessary for securing the high density in coloring. When the plasticizer is added into the resin of the dye receptor layer, it is important to pay attention to a mutual compatibility of the resin and the plasticizer. In a case where the styrene resin or the polycarbonate resin is used, addition of the plasticizer is common and the compatibility of these resins and the plasticizer is large. In contrast with this, the polyacetal resins have a small compatibility to the plasticizer commonly used, and they are not suitable for the addition of the plasticizer.

In addition, since the styrene resins has a basic construction of styrene, they have a small compatibility to resins used as a binder for dye such as cellulose resins including ethyl cellulose, hydroxyethyl cellulose, ethyl hydroxycellulose, hydroxypropyl cellulose, methyl cellulose, cellulose acetate, cellulose butyrate; vinyl resins including polyvinyl alcohol, polyvinyl butyral, polyvinylpyrrolidone, polyvinyl acetal; polyester; or the like. In other words, when the styrene resin is used as the material forming the dye receptor layer, the thermal transfer sheet bearing a dye and the thermal transfer image-receiving sheet show an excellent releasing performance at a printing process. Therefore, the dye receptor layer is imparted with a sufficient releasability even by addition of a small amount of a release agent, and a large density in coloring is secured because a small amount of the release agent hardly obstructs the dyeability.

Use of the resin having only a styrene-construction however limits to adaptability of the thermal transfer image-receiving sheet. That is, there is known a method in which a protect layer is transferred on a printed image for the purpose of improving fingerprint resistance or plasticizer resistance of a printed product, and though the dye receptor layer formed of the resin having only the styrene-construction is excellent in releasability, it can not fulfill a perfect transfer of the protect layer on the dye receptor layer, thus being a drawback. It is necessary to take such a point into consideration in order to obtain a thermal transfer image-receiving sheet applicable to various use. In view of this point, an acrylic construction is excellent in compatibility to various resins used for the protect layer, and then it has a good adhesion to the protect layer. Therefore, it becomes possible to eliminate the above described drawback by introducing the acrylic construction into the styrene resin.

When a polystyrene resin and an acrylic resin are merely mixed therewith, it is impossible to make the releasability of the dye receptor layer to the dye layer of the thermal transfer sheet consistent with the adhesion of the dye receptor layer to the protect layer. In contrast with this, when the dye receptor layer is formed with the use of a polymer having a chemical construction into which both of the styrene construction and the acrylic construction are incorporated, it is possible to make the releasability of the dye receptor layer to the dye layer of the thermal transfer sheet consistent with the adhesion of the dye receptor layer to the protect layer.

Thus, in the thermal transfer image-receiving sheet of the present invention, the copolymer comprising, as essential components, the styrene compound monomer and the acrylic compound monomer is used as a binder resin of the dye receptor layer. The styrene compound monomer has a basic construction included in a chemical construction of styrene. The acrylic compound monomer has a basic construction included in a chemical construction of acrylic acid It is preferable to use acrylonitrile, acrylic acid ester, acrylamide and methyl methacrylate as the acrylic compound monomer, and the acrylonitrile is particularly preferable. Plural kinds of the styrene compound monomers and/or plural kinds of the acrylic compound monomers may be incorporated into a single copolymer.

There may be exemplified, as the above described copolymer, styrene/acrylonitrile copolymer, styrene/acrylic acid copolymer, styrene/phenyl acrylate copolymer, styrene/methyl acrylate copolymer, styrene/ethyl acrylate copolymer, styrene/butyl acrylate copolymer, styrene/methyl methacrylate copolymer, styrene/acrylamide copolymer, styrene/ethylene/acrylonitrile copolymer, styrene/butadiene/acrylonitrile copolymer or the like.

When the resin having a grass transition temperature of 100° C. or over 100° C. is chosen among the copolymer comprising the styrene compound monomer and the acrylic compound monomer, it is possible to secure a particularly excellent light resistance without obstruction to a function of the plasticizer improving density in coloring. In general, when a grass transition temperature of a binder resin forming a dye receptor layer is high, the dye receptor layer is improved in light resistance, but deteriorated in dyeability, and the dyeability thereof is insufficient even by addition of a large amount of the plasticizer. In contrast with this, when the copolymer comprising the styrene compound monomer and the acrylic compound monomer is used as the binder resin of the dye receptor layer, it is possible to improve the dyeability of the dye receptor layer to the sufficient extent in spite of choice of the copolymer having a grass transition temperature of 100° C. or more.

As described above, the dye receptor layer contains one or more plasticizer as well as the copolymer. The plasticizer may be choose among the phosphoric ester compounds (i.e., phosphates), phthalic acid ester compounds (i.e., phthalates), trimellitic acid ester compounds (i.e., trimellitate) and dibasic aliphatic acid ester compounds (i.e., aliphatic diesters).

As preferable examples of the phosphoric ester compounds, there may be exemplified ones represented by the following formula(1):

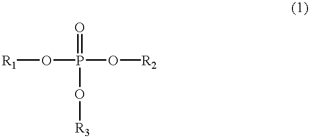

wherein R₁, R₂ and R₃ independently denote alkyl or aryl respectively.

As preferable examples of the phthalic acid ester compounds, there may be exemplified ones represented by the following formula(2):

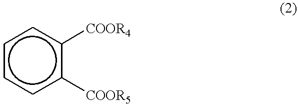

wherein R₄ and R₅ independently denote alkyl or aryl respectively.

As preferable examples of the trimellitic acid ester compounds, there may be exemplified ones represented by the following formula(3):

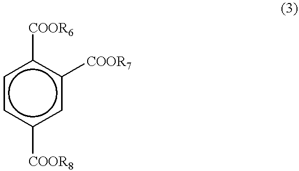

wherein R₆, R₇ and R₈ independently denote alkyl respectively.

As the alkyl group of R₁, R₂, R₃, R₄, R₅ R₆, R₇ and R₈, there may be exemplified methyl, ethyl, n-propyl, i-propyl, n-butyl, i-butyl, t-butyl, 2-ethylhexyl (i.e., octyl), cyclohexyl or the like. As the aryl group (i.e., aromatic group) of R₁, R₂, R₃, R₄ and R₅, there may be exemplified phenyl, tolyl, xylenyl, benzyl, 2-phenylethyl or the like.

Specific examples of the plasticizer include dimethyl phthalate, diethyl phthalate, dibutyl phthalate, dioctyl phthalate (i.e., 2-ethylhexyl phthalate), dicyclohexyl phthalate, diphenyl phthalate, trimethyl phosphate, tributyl phosphate, triethyl phosphate, triphenyl phosphate, tritolyl phosphate, trixylenyl phosphate, diphenyl tolyl phosphate, phenyl ditolyl phosphate, diphenyl xylenyl phosphate, diphenyl dixylenyl phosphate, tribenzyl phosphate, tri(2-phenylethyl) phosphate, dimethyl sebacate, dimethyl oxalate.

Since a preferable amount ratio of the copolymer and the plasticizer depends on a combination of the used copolymer and the used plasticizer, it is difficult to set the amount ratio to a single value, but it is usually controlled within a range of about 5:5 to 9:1 in term of weight ratio defined by an equation “copolymer: plasticizer”.

It is undesirable for the present invention to use a non-aromatic plasticizer having a long chain alkyl of eight or more carbon atoms such as dioctyl sebacate, dioctyl phosphate or the like.

The dye receptor layer may further contain a release agent. As the release agent, there may be used silicone resins or cross-linked products thereof. Of these silicone compounds, it is preferable to use an epoxy-modified silicone and a non-modified silicone, namely a silicone without any reactive functional group. The release agent may be used solely or in combination with two or more kinds. When the release agent is used, an amount ratio thereof is usually set within 0.1 to 25 weight parts with respect to 100 weight parts of an amount totalizing the copolymer and the plasticizer.

In order to improve density, sharpness or preservability of the formed image in correspondence with the recording-dye of the thermal transfer sheet, a resin conventionally used for forming the receptor layer may be incorporated into the above described copolymer. As such an additional resin, there may be used polyurethane resins, polyester resins, polycarbonate resins, polyamide resins, acrylic resins, cellulose resins, polysulfone resins, polyvinyl chloride resins, polyvinyl acetate resins, vinyl chloride/vinyl acetate copolymer resins, polyvinyl acetal resins, polyvinyl butyral resins, polypropylene resins, ethylene/vinyl acetate resins, epoxy resins or the like.

When such an additional resin is mixed with the above described copolymer, an amount ratio thereof is usually set within a range of about 5 to 50 weight parts with respect to 100 weight parts of the copolymer. With less than 5 weight parts of the additional resin, it may be difficult to lead a function of improvement or reformation out of the additional resin. With more than 50 weight parts of the additional resin, an excellent light resistance as an advantage of the styrene resins may be obstructed.

The dye receptor layer may be formed by dissolving and dispersing the above described copolymer, the plasticizer and the other additional materials in a solvent, applying the thus prepared coating solution on the substrate sheet through a known coating method such as gravure coating, and drying same.

(Intermediate Layer)

Any intermediate layer conventionally known may be interposed between the substrate sheet and the dye receptor layer for the purposes of imparting adhesion to the substrate sheet, whiteness, cushioning property, hiding property, antistatic property, anti-curling property or the like into the dye receptor layer.

As a binder resin for the intermediate layer, there may be used polyurethane resins, polyester resins, polycarbonate resins, polyamide resins, acrylic resins, polystyrene resins, polysulfone resins, polyvinyl chloride resins, polyvinyl acetate resins, vinyl chloride/vinyl acetate copolymer resins, polyvinyl acetal resins, polyvinyl butyral resins, polyvinyl alcohol resins, epoxy resins, cellulose resins, ethylene/vinyl acetate resins, polyethylene resins, polypropylene resins, or the like. Among these resins, ones having active hydrogen may be reacted with isocyanate, and the thus obtained hardened products can also used as the binder of the intermediate layer.

For the purpose of imparting whiteness and hiding property, it is preferable to add a filler such as titanium oxide, zinc oxide, magnesium carbonate, calcium carbonate or the like.

Besides there may be added: stilbene compounds, benzoimidazole compounds, benzoxazole compounds or the like as a fluorescent whitening agent for improving whiteness; hindered amine compounds, hindered phenol compounds, benzophenone compounds or the like as an ultraviolet absorbent or an antioxidant for improving light resistance of the printed product; cationic acrylic resin, polyaniline resins, various conductive fillers or the like for imparting antistatic property.

(Back Surface Layer)

Any back surface layer conventionally known may be provided on a surface of the substrate sheet opposite to the other surface having the dye receptor layer for the purpose of imparting fitness with a conveying or carrying operation, writing property, antistatic property, anti-staining property, anti-curling property or the like.

(The Others)

In view of the antistatic property, an antistatic layer containing a known antistatic agent may be provided on the dye receptor layer and/or the back surface layer.

According to the thermal transfer image-receiving sheet of the present invention, it is possible to form an image excellent in density of coloring, sharpness/clearness and durability in various aspects, in particular light resistance.

### EXAMPLES

Hereinafter, the thermal transfer image-receiving sheet of the present invention will be described in more detail with demonstration of experimental examples and comparison examples.

### Example 1

A coating solution for white intermediate layer having the following composition was applied on one surface of the following substrate sheet to form an intermediate layer having a thickness of 2 μm.

<Substrate Sheet>

A synthetic paper having a thickness of 150 μm (YUPO FPG#150, manufactured by Ohji Yuka Corporation).

<Coating Solution for White Intermediate Layer>

Polyester resin (WR-905, manufactured by Nihon Gousei Kagaku Kougyo Corporation): 25 weight parts

Water soluble-fluorescent whitening agent (Uvitex BAC, manufactured by Ciba Geigy Corporation): 1 weight parts

Titanium oxide (TCA-88, manufactured by Tohchem Products Corporation): 75 weight parts

Water/Isopropyl alcohol (1/1): 400 weight parts

Next, a coating solution for dye receptor layer having the following composition was applied on the intermediate layer to form a dye receptor layer having a thickness of 5 μm, thus producing a thermal transfer image-receiving sheet.

<Coating Solution for Dye Receptor Layer>

Styrene/acrylonitrile copolymer (SEBIAN JD, Tg: 110-115° C., manufactured by Daisel Kagaku Kougyo Corporation): 70 weight parts

Dicyclohexyl phthalate: 30 weight parts

Epoxy-modified silicone (X-22-3000T, manufactured by Shin-Etsu Kagaku Kougyo Corporation): 5 weight parts

Methyl ethyl ketone(MEK)/Toluene (1/1): 400 weight parts

The dye receptor layer of the produced thermal transfer image-receiving sheet and a dye layer of a thermal transfer film (PK700L for Video Printer CP-700, manufactured by Mitsubishi Electronics Corporation) were made opposite to each other, and superposed. Heating was then performed from a back surface of the thermal transfer film by means of a thermal head, thus carrying out a thermal transfer recording of yellow, magenta and cyan in the following condition. Then, evaluation was carried out in the following manners with respect to heat resistance before printing, light resistance, heat resistance and density in printing. Results of the evaluation are shown in Table 1.

<Printing Condition>

Thermal head: KGT-217-12MPL20 (manufactured by Kyocera)

Mean resistance of heating element: 3195Ω

Printing density of main scanning direction: 300 dpi

Printing density of sub-scanning direction: 300 dpi

Impressed power: 0.12 w/dot

Cycle of single line: 5 msec.

Initial temperature of printing: 40° C.

Procedure for gradation-control: Used was a test printer based on a multi-pulse system, which was able to change number of divided pulses within a range of 0(zero) to 255 pieces during the cycle of the single line, and each of the divided pulses had a pulse length as obtained by equally dividing the cycle of the single line into 256 pieces. A duty ratio of the each divided pulse was fixed at 60%, and gradation was controlled within a range of sixteen gradation-levels consisting of a 0(zero) step to a fifteenth step in such manner that number of the pulses per the cycle of the single line was successively increased by seventeen pieces within a range from 0(zero) to 255 pieces in correspondence with a required gradation, for example, 0 pieces at 0 step, 17 pieces at 1 step, and 34 pieces at 2 step.

<Heat Resistance before Printing>

Test and evaluation of the heat resistance before printing were carried out in the following manner.

Two pieces of the produced thermal transfer image-receiving sheet were used, and one was preserved in an ordinary temperature for one hundred hours, and the other was preserved in an oven at 60° C. for the same period. After the preservation, each colored gradation of yellow, magenta and cyan was printed on the respective thermal transfer image-receiving sheets with the use of the above described thermal transfer film in the above described printing condition.

For the thus printed products, an optical reflection density of each step was measured by means of a densitometer (MACBETH RD-918, manufactured Macbeth corporation). As to the printed product converted from the thermal transfer image-receiving sheet preserved in the ordinary temperature, measured values of the optical reflection density thereof were defined as (OD)0. On the other hand, as to the printed product converted from the thermal transfer image-receiving sheet preserved at 60° C., the optical reflection density thereof were defined as (OD)1. Then, (OD)0 of an individual combination of color and step and (OD) 1 of the same combination were substituted for (or incorporated into) the following equation, thereby calculating change ratio of the gamma(γ) characteristics.

Change ratio (%)=((OD)1−(OD)0)×100/(OD)0

After the calculation, the maximum value of the change ratio among the all combinations of color and step was defined as a representative which indicates stability of the thermal transfer image-receiving sheet preserved at a high temperature before printing, and the obtained representative value was evaluated on the basis of the following criteria.

◯: Change ratio was less than 10%.

Δ: Change ratio was 10% or more and less than 20%.

X: Change ratio was 20% or more.

<Light Resistance>

Test and evaluation of the light resistance were carried out in the following manner.

Thermal transfer recording was carried out with the use of the thermal transfer image-receiving sheet produced as described above and the above described thermal transfer film in the above described printing condition, and a printed cyan color was subjected to a test of light resistance in the following condition.

Irradiation testing machine: Ci 135, manufactured by Atlas Corporation

Light source: Xenon lamp

Filter: IR filter for the inside, and soda lime grass for the outside.

Temperature of black panel: 45° C.

Irradiation intensity: 1.2 w/m² as a measured value at 420 nm

Irradiation energy: 200 Kj/m² as an accumulated value at 420 nm

Optical reflection density was measured before and after the irradiation with respect to a step having a value of optical reflection density near 1.0 before the irradiation, and remaining ratio of density was calculated by the following equation.

Remaining ratio (%)=( (optical reflection density after the irradiation)/(same before the irradiation))×100

The thus obtained remaining ratio was evaluated on the basis of the following criteria.

◯: Remaining ratio was 80% or more.

Δ: Remaining ratio was 70% or more and less than 80%.

X: Remaining ratio was less than 70%.

<Heat Resistance>

Test and evaluation of the heat resistance were carried out in the following manner.

Thermal transfer recording was carried out with the use of the thermal transfer image-receiving sheet produced as described above and the above described thermal transfer film in the above described printing condition. Thus obtained printed product was left in an oven at a temperature of 60° C. for 100 hours, and thereafter blur of the image was observed by means of a magnifying glass having magnification of 25 times. A magnified appearance was evaluated on the basis of the following criteria.

◯: A large change of dot size was not observed.

Δ: Diffusion of dots was observed, but a distinct blur was not observed in a visual observation.

X: The dye was diffused even to a non-printed site, and a distinct blur was observed by a visual observation.

<Printing Density>

Thermal transfer recording was carried out with the use of the thermal transfer image-receiving sheet produced as described above and the above described thermal transfer film in the above described printing condition. Optical reflection density (OD value) of the image formed on the printed product was measured, and evaluated on the basis of the following criteria.

◯: When an optical reflection density of Comparison Example 2 was used as a standard of printing density, a ratio of the optical reflection density was 98% or more in a printing condition showing an OD value near 1.

X: When an optical reflection density of Comparison Example 2 was used as a standard, a ratio of the optical density was less than 98% in a printing condition showing an OD value near 1.

### Example 2

A thermal transfer image-receiving sheet was produced in the same manner as that in the Example 1 except that a coating solution for dye receptor layer 2 having the following composition was used instead of the coating solution for dye receptor layer 1. Then, the produced thermal transfer image-receiving sheet was tested and evaluated in the same manner as that in the Example 1. Results of the evaluation are shown in Table 1.

<Coating Solution for Dye Receptor Layer 2>

Styrene/acrylonitrile copolymer (SEBLAN JD, Tg: 110-115° C., manufactured by Daisel Kagaku Kougyo Corporation): 70 weight parts

Diphenyl phthalate: 30 weight parts

Epoxy-modified silicone (X-22-3000T, manufactured by Shin-Etsu Kagaku Kougyo Corporation): 5 weight parts

MEK/Toluene (1/1): 400 weight parts

### Example 3

A thermal transfer image-receiving sheet was produced in the same manner as that in the Example 1 except that a coating solution for dye receptor layer 3 having the following composition was used instead of the coating solution for dye receptor layer 1. Then, the produced thermal transfer image-receiving sheet was tested and evaluated in the same manner as that in the Example 1. Results of the evaluation are shown in Table 1.

<Coating Solution for Dye Receptor Layer 3>

Styrene/acrylonitrile copolymer (SEBIAN JD, Tg: 110-115° C., manufactured by Daisel Kagaku Kougyo Corporation): 85 weight parts

Dioctyl phthalate: 15 weight parts

Epoxy-modified silicone (X-22-3000T, manufactured by Shin-Etsu Kagaku Kougyo Corporation): 5 weight parts

MEK/Toluene (1/1): 400 weight parts

### Example 4

A thermal transfer image-receiving sheet was produced in the same manner as that in the Example 1 except that a coating solution for dye receptor layer 4 having the following composition was used instead of the coating solution for dye receptor layer 1. Then, the produced thermal transfer image-receiving sheet was tested and evaluated in the same manner as that in the Example 1. Results of the evaluation are shown in Table 1.

<Coating Solution for Dye Receptor Layer 4>

Styrene/acrylonitrile copolymer (SEBIAN JD, Tg: 110-115° C., manufactured by Daisel Kagaku Kougyo Corporation): 70 weight parts

Triphenyl phosphate: 30 weight parts

Epoxy-modified silicone (X-22-3000T, manufactured by Shin-Etsu Kagaku Kougyo Corporation): 5 weight parts

MEK/Toluene (1/1): 400 weight parts

### Example 5

A thermal transfer image-receiving sheet was produced in the same manner as that in the Example 1 except that a coating solution for dye receptor layer 5 having the following composition was used instead of the coating solution for dye receptor layer 1. Then, the produced thermal transfer image-receiving sheet was tested and evaluated in the same manner as that in the Example 1. Results of the evaluation are shown in Table 1.

<Coating Solution for Dye Receptor Layer 5>

Styrene/acrylonitrile copolymer (SEBIAN JD, Tg: 110-115° C., manufactured by Daisel Kagaku Kougyo Corporation): 70 weight parts

Trioctyl trimellitate: 30 weight parts

Epoxy-modified silicone (X-22-3000T, manufactured by Shin-Etsu Kagaku Kougyo Corporation): 5 weight parts

MEK/Toluene (1/1): 400 weight parts

### Comparison Example 1

A thermal transfer image-receiving sheet was produced in the same manner as that in the Example 1 except that a coating solution for dye receptor layer b1 having the following composition was used instead of the coating solution for dye receptor layer 1. Then, the produced thermal transfer image-receiving sheet was tested and evaluated in the same manner as that in the Example 1. Results of the evaluation are shown in Table 1.

<Coating Solution for Dye Receptor Layer b1>

Styrene/acrylonitrile copolymer (SEBIAN JD, Tg: 110-115° C., manufactured by Daisel Kagaku Kougyo Corporation): 100 weight parts

Epoxy-modified silicone (X-22-3000T, manufactured by Shin-Etsu Kagaku Kougyo Corporation): 5 weight parts

MEK/Toluene: 400 weight parts

### Comparison Example 2

A thermal transfer image-receiving sheet was produced in the same manner as that in the Example 1 except that a coating solution for dye receptor layer b2 having the following composition was used instead of the coating solution for dye receptor layer 1. Then, the produced thermal transfer image-receiving sheet was tested and evaluated in the same manner as that in the Example 1. Results of the evaluation are shown in Table 1.

<Coating Solution for Dye Receptor Layer b2>

Polystyrene (Tg: 90° C.): 100 weight parts

Dicyclohexyl phthalate: 30 weight parts Epoxy-modified silicone (X-22-3000T, manufactured by Shin-Etsu Kagaku Kougyo Corporation): 5 weight parts

MEK/Toluene (1/1): 400 weight parts

(Discussion in Test Results)

As apparent from the following Table 1, the thermal transfer image-receiving sheet of the Comparison Example 1 was inferior in printing density, and the thermal transfer image-receiving sheet of the Comparison Example 2 was inferior in heat resistance. In contrast with this, the thermal transfer image-receiving sheet of the Examples 1 to 5 showed excellent performances in all tests, i.e., heat resistance before printing, light resistance, heat resistance and density in printing.

The above tests confirmed that the thermal transfer image-receiving sheet of the present invention is capable of forming an image excellent in coloring, sharpness/clearness and durability in various aspects, in light resistance.

TABLE 1

| | Heat Resistance | Light | Heat | Printing |
|---|---|---|---|---|
| | before Printing | Resistance | Resistance | Density |
| Examples | | | | |
| 1 | ◯ | ◯ | ◯ | ◯ |
| 2 | ◯ | ◯ | ◯ | ◯ |
| 3 | ◯ | ◯ | ◯ | ◯ |
| 4 | ◯ | ◯ | ◯ | ◯ |
| 5 | ◯ | ◯ | ◯ | ◯ |
| Comparison | | | | |
| Example | | | | |
| 1 | ◯ | ◯ | ◯ | X |
| 2 | ◯ | ◯ | X | standard |

What is claimed is

1. A thermal transfer image-receiving sheet comprising a substrate sheet and a dye receptor layer disposed on at least one surface side of the substrate sheet, the dye receptor layer comprising a copolymer and a plasticizer, the copolymer comprising styrene compound monomer and acrylic compound monomer, and the plasticizer being selected from the group consisting of phosphoric ester compounds, phthalic acid ester compounds, trimellitic acid ester compounds and dibasic aliphatic acid ester compounds.

2. A thermal transfer image-receiving sheet according to claim 1, wherein said acrylic compound monomer is at least one selected from the group consisting of acrylonitrile, acrylic acid ester, acrylamide and methyl methacrylate.

3. A thermal transfer image-receiving sheet according to claim 2, wherein said acrylic compound monomer is acrylonitrile.

4. A thermal transfer image-receiving sheet according to claim 1, wherein an amount ratio of said copolymer and said plasticizer (copolymer: plasticizer) is in a range of 5:5 to 9:1 in weight.

5. A thermal transfer image-receiving sheet according to claim 1, wherein said dye receptor layer further comprises a release agent selected from the group consisting of silicone resins and cross-linked products thereof.

6. A thermal transfer image-receiving sheet according to claim 5, wherein said release agent is at least one selected from the group consisting of epoxy-modified silicones and non-modified silicones.

7. A thermal transfer image-receiving sheet according to claim 1, wherein said copolymer has a grass transition temperature of 100° C. or more.
